(19) United States
(12) Patent Application Publication
(10) Pub. No.: US 2014/0305460 A1
(43) Pub. Date: Oct. 16, 2014

(54) DENTAL FLOSSER

(71) Applicant: Teklemichael Sebhatu, London (GB)

(72) Inventor: Teklemichael Sebhatu, London (GB)

(21) Appl. No.: 13/976,833

(22) PCT Filed: Dec. 30, 2011
(86) PCT No.: PCT/GB2011/052596

§ 371 Date: Oct. 18, 2013

(30) Foreign Application Priority Data
Dec. 30, 2010 (GB) 1022087.9
May 10, 2011 (GB) 1107771.6

(51) Int. Cl. A61C 15/04

(52) U.S. Cl. CPC A61C 15/046
USPC 132/200; 132/323

(57) ABSTRACT

A dental flosser (2) comprising a tensioning structure (8, 10, 12) for holding a section of a dental floss for flossing. The dental floss (14) is of continuous length and has on said length a plurality of spaced nodes (30) defining a plurality of sections. The tensioning structure is arranged to apply a tensioning action to a pair of nodes on said length to tension the section (14) defined by the pair. The tensioning structure is so arranged so that the section is replaceable with another one of the sections (14b). A method of operating a dental flosser comprises a) operating the dental flosser to at least partially remove a tensioning action acting on each of the pairs of nodes of the section to tension the section, b) removing the section from the position and locating the other section in the position, and c) applying a tensioning action to the pair of nodes defining the other section.

### FIELD OF THE INVENTION

The invention relates to a dental flosser. The invention also relates to a dental floss and a method of operating a dental flosser.

### BACKGROUND TO THE INVENTION

Cleaning spaces between teeth is important in dental hygiene and it is known to use dental floss for this. Dental floss may be held and guided using fingers, but use thereof may be facilitated and efficacy improved by using a device for holding the dental floss. Various devices for holding dental floss are known. In some of these, dental floss is drawn and held between a pair of spaced holder elements, which are attached to a handle. In such devices, mechanical arrangements for supplying the dental floss and for maintaining a suitable tension in the dental floss between the holder elements are complex; such known devices are commercially unviable due to their manufacturing costs and may be inconvenient to use. In some such devices, maintaining a tension suitable for flossing between the pair of holder elements is not achieved.

A known document, FR2450603, describes a device for massaging of gums by vibration. The device is made of hard, transparent plastic material. The device comprises a fork having two branches of unequal length. Tensioned nylon cord is disposed between two ends of the branches. The cord is made to pass down channels located on respective external faces of the branches. The cord is fixed by drawing four massage elements from the device and locating the two central elements of the four between the branches. The two other massage elements are wedged in respective cavities at the base of each branch. Each branch has lesser cross-sectional area at its top than at its base, to prevent flexing of the branch. In use, a motor causes vibration of the cord. The cord, helped by the vibration, passes between the teeth, massaging in the spaces between teeth, so that the two central massaging elements are directed towards the concave regions of the gum and massage and tone these regions. A drawback to this device is that a high degree of tension in the cord is not achieved; the cord is liable to come loose. Also, after the cord has been cut, there is little cord to grasp in order to release the cord from the device.

It is an object of the present invention to provide an improved dental flosser, in particular in which these problems are overcome.

### SUMMARY OF THE INVENTION

According to the present invention, there is provided a dental flosser comprising a tensioning structure for holding a section of a dental floss for flossing, the dental floss being of continuous length and having on said length a plurality of spaced nodes defining a plurality of sections, wherein the tensioning structure is arranged to apply a tensioning action to a pair of nodes on said length, the pair defining a one of the sections, thereby to tension the section, and so that the one section is replaceable with another one of the sections on said length, replacement including drawing of dental floss from an unused portion of the dental floss, wherein the tensioning structure is operable to at least partially remove said tensioning action from the pair of nodes.

Thus, each section of dental floss may be replaced with another section in a simple manner. This dental flosser addresses the drawbacks of the prior art. In particular, since the tensioning structure can be operated to at least partially remove the tensioning action, greater tension can be provided in the floss to facilitate flossing and to prevent the floss becoming loose during robust flossing. In FR2450603, since the cord would be difficult to grip, it would be especially difficult to pull the cord againsÍt the tension in it to release the cord if the tension were sufficient for flossing. Also, the dental flosser is inexpensive to manufacture.

The pair of nodes defining the one section may be adjacent nodes. The tensioning structure may be arranged to apply said tensioning action to the pair of the nodes defining the other section after locating of the other section in the tensioning structure, for example if the node is located in the tensioning structure in a snap-fit engagement. The tensioning structure may be operable to at least partially remove said tensioning action from the pair of nodes by application of finger pressure. Alternatively, the tensioning structure may be operable to apply the tensioning action to the pair of nodes defining the other section after locating of the other section in the tensioning structure, the operation, for example, being by means of a switch.

The tensioning structure may comprise a switching means operable to switch between a first state wherein said tensioning action is applied to nodes defining a section on said length and a second state wherein said tensioning action is at least partly removed from said nodes. The switching means may comprise a resiliently flexible portion, flexing thereof at least partly removing said tensioning action.

The tensioning structure may comprise first and second members each for applying a tensioning action to a respective one of a pair of nodes defining a section. The first and second members may be joined by a bridge. The tensioning action may be at least partially removed by flexing of the bridge by finger pressure.

The first member may comprise a first floss guiding slot sized to prevent passage of a node therethrough, wherein the tensioning action comprises the action of the walls of the slot on a one of the pair of nodes. The second member may comprise a second floss guiding slot sized to prevent passage of a node therethrough, wherein the tensioning action comprises the action of the walls of the slot on the other of the pair of nodes.

When tension in the section of the dental floss is at least partially removed, the one node may be releasable from the first member and/or the second member. When tension in the section of the dental floss is at least partially removed, the other node may be releasable from the second member.

The dental flosser may further comprise a cutter for cutting the dental floss and located for cutting at least a part of the length of the dental floss after it has been removed from between said first and second members.

The dental flosser may substantially contain an unused portion of the dental floss.

The dental flosser may further comprise a body defining a chamber containing the unused dental floss. The unused dental floss may be loose within the chamber. The chamber may contain a cleaning material for oral hygiene. The body defines an aperture in a wall of the chamber through which dental floss is drawn, the dental flosser further comprising a valve at the aperture for substantially preventing leakage of the cleaning material from the chamber.

The body may comprise a handle.

The length of a section may substantially correspond to a length of dental floss that the tensioning structure is arranged to hold.

According to the present invention, there is further provided a dental floss having a plurality of regularly spaced nodes thereon, each pair of adjacent nodes defining a section therebetween, wherein each section has a length of 26 mm to 39 mm. Each section may have a length of 25 mm to 35 mm. The dental floss may be for use in the dental flosser described above.

According to the present invention, there is further provided a dental flosser comprising a tensioning structure for holding a section of a dental floss for flossing, the dental floss being of continuous length and having on said length a plurality of spaced nodes defining a plurality of sections, wherein the tensioning structure is arranged to apply a tensioning action to a pair of nodes on said length, the pair defining a one of the sections, to tension the section, the tensioning structure being arranged so that the one section is replaceable with another one of the sections on said length, wherein the section of floss located for flossed is located substantially parallel to the axis of the handle of the dental flosser. Having the floss which is in a position for flossing locating in this way facilitates flossing.

According to the present invention, there is yet further provided a dental flosser comprising a tensioning structure for holding a section of a dental floss for flossing, the dental floss being of continuous length and having on said length a plurality of spaced nodes defining a plurality of sections, wherein the tensioning structure is arranged to apply a tensioning action to a pair of nodes on said length, the pair defining a one of the sections, to tension the section, the tensioning structure being arranged so that the one section is replaceable with another one of the sections on said length, wherein the length of a section substantially corresponds to a length of dental floss that the tensioning structure is arranged to hold. In comparison to FR2450603, it can be seen that the length dental floss is more efficiently used and/or used cord is not necessarily retained.

According to the present invention, there is furthermore provided a method of operating a dental floss holder to replace a section of dental floss held in a position for flossing with another section of the dental floss, the dental floss being of continuous length and having a plurality of spaced nodes thereon, pairs of the nodes defining sections, the method comprising operating the dental floss holder to at least partially remove tension in the section removing the section from the position and arranging the other section in the position for flossing and so that a tensioning action is applied to the pair of nodes defining the other section, wherein arranging the other section comprises drawing dental floss from an unused portion of the dental floss. The unused portion may be within the dental flosser. The method may be a method of operating of any of the dental flossers described above.

The dental floss holder may comprise a tensioning structure and the operating the dental floss holder to at least partially remove tension in the section may comprise flexing the tensioning structure using finger pressure to reduce tension in the section. The finger pressure may be applied by fingers of a same hand as the hand that grips a handle of the dental floss holder.

The arranging the other section in a position for flossing may comprise removing the pair of nodes from the tensioning structure and locating another pair of nodes defining the other section in the tensioning structure. This may be achieved by pulling on an end of the floss in a first direction to release a one of the nodes from the tensioning structure, and then pulling the end of the floss in another direction to release the other node of the pair.

The nodes of the other section may then be located so that the other section is secured in the flossing position by further pulling of the end of the floss in at least one particular direction. The nodes of the other section may engage in the tensioning structure such that the other section is tensioned and in the flossing position, for example by snap-fit engagement. Used floss may be substantially cut away.

The length of a section may substantially correspond to a length of dental floss that the tensioning structure is arranged to hold.

According to a yet further aspect of the present invention, there is provided apparatus for supplying dental floss comprising a body defining a chamber containing a supply of dental floss and a cleaning material, wherein dental floss drawn from the body includes said cleaning material thereon and/or absorbed therein. The cleaning material may be a dentifrice. The dentifrice may be a liquid, gel or paste dentifrice. The apparatus may further comprise valve means for substantially preventing egress/leakage of the cleaning material from the chamber. The value means may be located at an aperture in a wall of the chamber through which the dental floss is drawn. Unused dental floss may be loose within the chamber.

There may be further provided a dental flosser comprising apparatus according to any one of the preceding claims, and means for holding a section of drawn dental floss for flossing.

### BRIEF DESCRIPTION OF THE DRAWINGS

For better understanding of the present invention, embodiments will now be described, by way of example only, with reference to the accompanying figures in which:

FIG. 1 is a side view of a dental flosser according to a first embodiment of the invention;

FIG. 2 is a perspective view of the dental flosser shown in FIG. 1;

FIG. 3 is a cross-sectional view through the dental flosser shown in FIGS. 1 and 2;

FIG. 4 is a cross-sectional view of a dental flosser in accordance with a second embodiment of the invention; and

FIG. 5 is a cross sectional schematic view of a dental flosser in accordance with a third embodiment of the invention.

Like parts are denoted by like reference numerals throughout.

### DETAILED DESCRIPTION OF EMBODIMENTS OF THE INVENTION

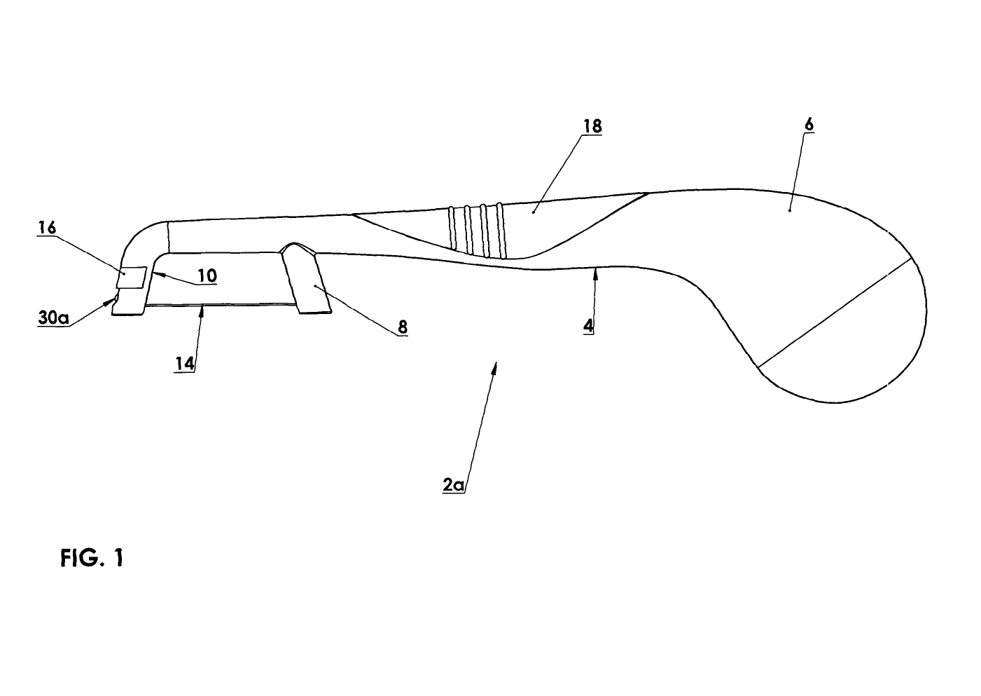

Referring to FIG. 1, the dental flosser, indicated generally at 2, includes a body 4 having a first end forming a handle 6 and a second end comprising a dental floss holding arrangement. The body 4 is hollow and defines a chamber (not shown in FIG. 1) containing a supply of dental floss, described below.

The dental floss holding arrangement includes a tensioning structure comprising first and second holder members, respectively indicated at 8 and 10, and a resiliently flexible bridge 12 joining the first and second holder members 8, 10. The first and second holder members 8, 10 are arranged to hold dental floss 14 therebetween at a suitable tension for flossing and to allow change of the section of the dental floss 14 held for flossing, which will be described in detail below. A cutter 16 for cutting dental floss 14 is fixed to the second holder member 10. The dental flosser 2a includes a grip 18 on the exterior of the body 4 to facilitate use.

The section of floss held under tension by the tensioning structure is parallel to and spaced from the axis of the handle 6.

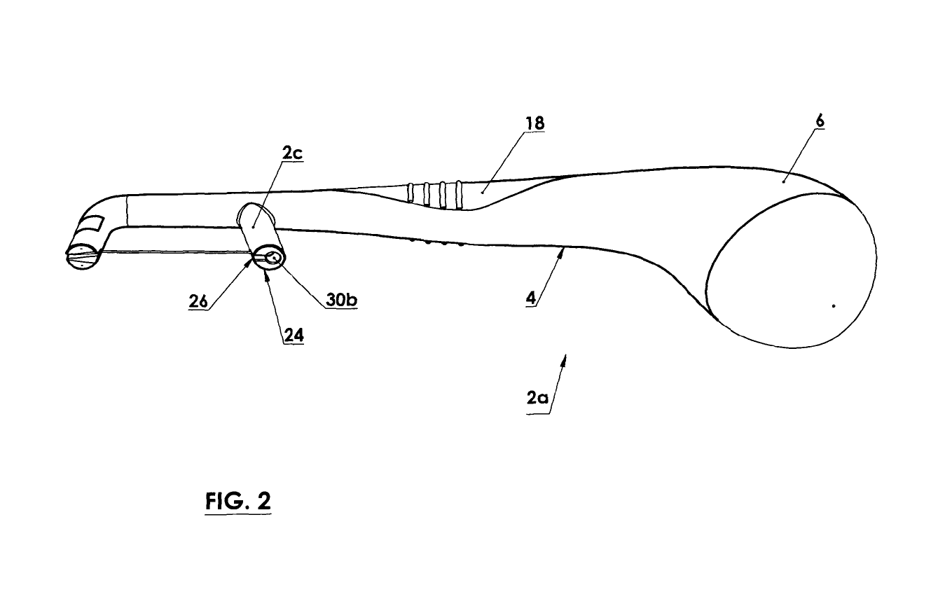

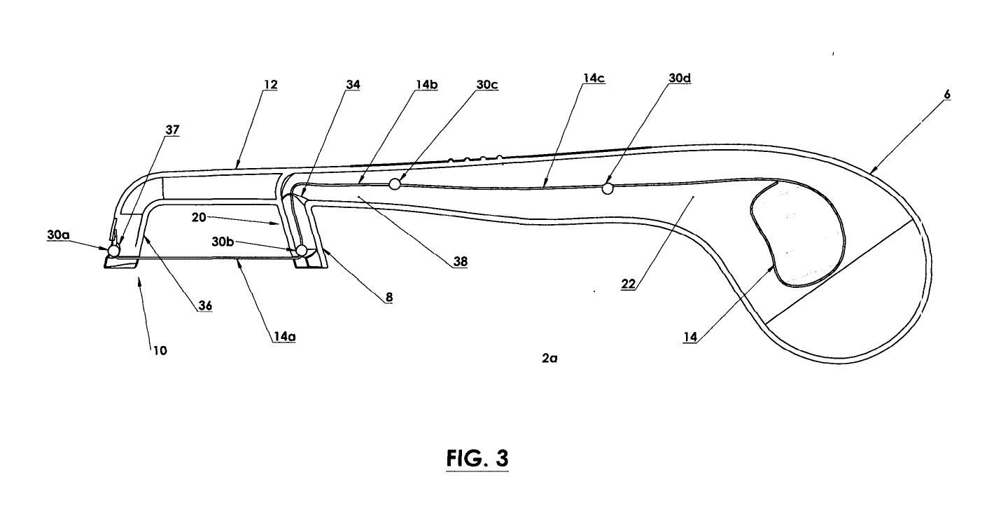

Referring to FIGS. 2 and 3, the first holder member 8 comprises a hollow first tube 20 formed of a longitudinal side and having a first end and a second end. The second end of the first tube 20 is joined with the rest of the body 4 so as to form a passage from the interior of the tube into the chamber, indicated at 22. The first end is part open. The first end is formed of a first closure part 24 integrally formed with the first tube 20, which has therein a keyhole shaped eyelet 26. The keyhole shaped eyelet 26 is, as the name suggests, a circular aperture having a slot aperture with width less than the diameter of the circular aperture extending from the periphery of the circular aperture to the periphery of the tube. The slot aperture extends from the circular aperture towards the second holder member 10.

A supply of dental floss 14, indicated generally at 28, is located in the body 4, mostly in the chamber 22 and has an end extending out of the body 4 through the first holder member 8. The dental floss 6 has a plurality of regularly spaced nodes 30 thereon in the form of hard, plastic balls (although the invention is not limited to nodes of any particular form or material). The nodes have a greater width than the width of the dental floss 14. A first node is indicated at 30a, a second node at 30b, a third node at 30c, and so on. Each pair of adjacent nodes 30 defines a section of the dental floss 14. A first section, defined by the first and second nodes 30a, 30b, is indicated at 14a; a second section, defined by the second and third nodes 30b, 30c is indicated at 14b, and so on.

In the first holder member 8, the slot aperture is sized to allow the sections of floss to pass therethrough and prevent passage of the node. The circular aperture is sized to allow passage of the nodes and the sections of the dental floss.

The second holder member 10 comprises a hollow second tube 36 and a second closure part. The second tube is formed of a longitudinal side extending at an end thereof from the bridge 12. The second closure part has a slot (not shown) extending therethrough, the slot being aligned lengthwise with the slot aperture of the keyhole shaped eyelet 26 of the first holder member 10. The slot has width less than that of the nodes 10 such that the nodes cannot pass through. The second tube 36 has a part spherical recess 37 for receiving the node 30a, located in a part of its surface remote from first holder member 8 and adjacent the slot. The slot extends into the recess, such that the dental floss 14 can extend through the slot and the node 30a sits in the part spherical recess when pulled by the floss, and abuts against the second holder member 10. In FIG. 3, the first node 30a on the dental floss 14 is shown located in said part spherical recess.

The dental floss 14 extends through a passage 38 in the body 4 to the first holder member 8. A fillet 34 is formed in an interior surface of the body 4 in the region of a corner between the first holder member 8 and the rest of the body 4. This reduces the force needed to draw the dental floss 14 from the body 4.

The first section 14a of the dental floss extends between the first and second holder members 8, 10. The first holder member 8 provides a tensioning action on the first section 14a by acting on the second node 30b and the second holder member 10 provides a tensioning action on the first section 14a by acting on the first node 30a, the first and second holder members 8, 10 thereby holding the first section 14a taut. The first and second holder members 8, 10 act on the adjacent nodes 30a, 30b in respectively opposite directions.

A section of the floss is substantially within the dental flosser until it is pulled into a flossing position. This keeps the floss substantially free from contamination. After a section of floss has been used and removed from the flossing position, it is cut such that most of the used floss is cut away. Thus most used floss can be quickly discarded.

The section of dental floss 14 between the first and second holder members 8, 10 can be replaced with another section of the dental floss in the steps described in the following.

In step (i), the dental floss is operated to at least partially remove the tensioning action acting on the first and second nodes 30a, 30b. In step (ii), the first section 14a of dental floss is removed from the tensioning structure. In step (iii) the second node 30b is removed from the tensioning structure and the dental floss is drawn so that the third node 30c is located abutting against a wall of first holder member 8. In step (iv) the second node 30b is arranged by a user in engagement with the second holder member such that the second section 14b is tensioned. In step (v) the first section 14a is at least partially removed by cutting. At least steps (i) to (iv) may be performed in a smooth action by the user. These steps are now described in greater detail.

(i) A user begins by releasing tension in the section 14a. This is done by a user applying finger pressure to the bridge 12 so that the bridge 12 flexes such that tension in the section 14a of dental floss is slack or at least at reduced tension. The user can do this while gripping the handle of the flosser, with fingers of the same hand used for gripping. The user then grips the first node 30a between his or her fingers and pulls the first node 30a away from the part spherical recess 37. The user then lifts the first node 30a so that the part of section 14a of the dental floss in the slot comes free from the slot. The user then releases the finger pressure.

(ii) On further movement of the section 14a away from the first holder member 8, the first section 14a moves out of the slot aperture in the first holder member 8. The second node 30b is then pulled from the first holder member 8 through the circular aperture of the keyhole opening. The first and second nodes 30a, 30b have thus now been removed from their previous positions within the first and second holder members 8, 10.

(iii) The second section 14b is then drawn from the inside of the body 4 until it is located in the flossing position between the first and second holder members 8, 10. This is done by drawing the dental floss towards the second holder member 10 so that the second section 14b of the dental floss is made to pass through the slot aperture of the keyhole opening. The dental floss 14 is drawn until the third node 30c abuts against the inside surface of the longitudinal tube of the first holder member 8 and walls of the slot aperture.

(iv) The second node 30b is then drawn over the second holder member 10 so that the section 14b extends through the slot in the closure part of the second holder member. The second node 30b can then be pulled to the part spherical recess into which it engages with snap-fit engagement, resilient flexibility in the tensioning structure enabling the snap-fit engagement.

(v) The first section 14a of the dental floss can then be cut or part cut from the remainder of the dental floss using the cutter.

In a modification, it may be desirable or necessary for a user to apply finger pressure in step (iv) for the second node 30b to be located in the part spherical recess. In this case, after location, finger pressure is released and the second section 14b becomes taut.

The dental flosser is formed in two pieces of injection moulded plastic. The dental floss is located inside with an end extending from the first holder member 4. The two pieces are then joined together, by gluing or other method of bonding, in accordance with techniques known to skilled persons. Alternative construction methods are possible and would be conceivable by suitably skilled persons.

The floss is preferably loose in the body 4 and arranged to prevent knotting. For example, the dental floss 14 may have been wound on a bobbin and then the bobbin removed, either before location of the dental floss in the casing or after. The axis of the bobbin may be located in the body 4 such that the axis of the spool is aligned with the direction in which the dental floss is drawn. In a modification, a rotatable hub may be provided optionally with ends attached to the body 4.

The resilience of the bridge is such that the dental floss remains taut during flossing, and also can be flexed sufficiently under finger pressure so that a section of floss held between the first and second holder members can be released.

In a prototype, the length of each section, that is, the length of the dental floss 14 between adjacent nodes 30 was 29 mm. Preferably, the length of the dental floss between adjacent nodes is 26 mm to 39 mm, preferably 26 mm to 37 mm, preferably still 26 mm to 35 mm and yet preferably still 30 mm to 35 mm.

Optionally, the dental flosser is disposable. However the dental flosser 2 may be openable for refilling with a new supply of dental floss—the body could include a closably openable section to enable this. In a modification, the body 4 may be adapted to receive a casing containing a new supply of dental floss, the dental flosser being adapted so that dental floss from the new supply can be drawn into a position for flossing.

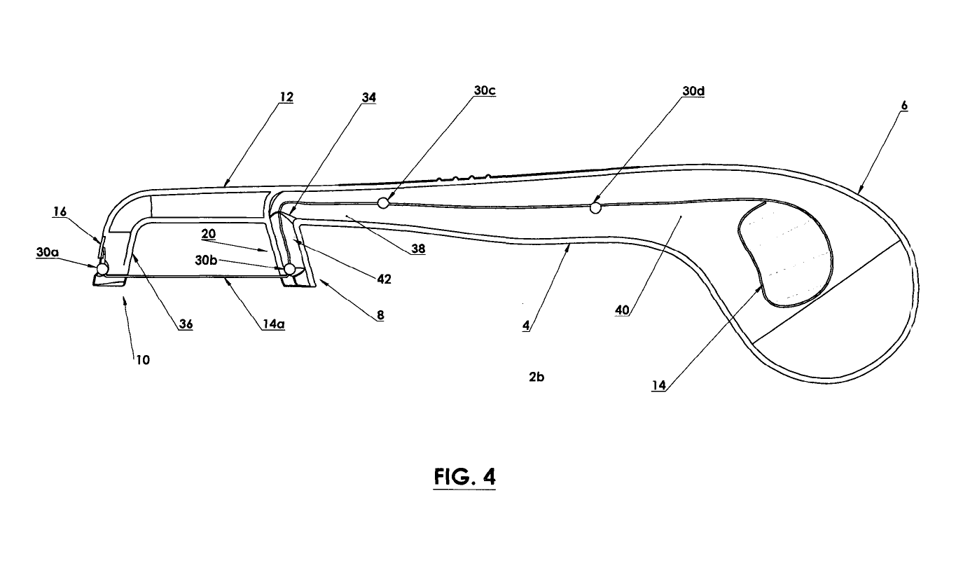

Referring to FIG. 4, in a second embodiment, the dental flosser indicated at 2b is as in the first embodiment with the modification described in the following. A cleaning material 40 for oral hygiene is located within the body 4 together with the supply of dental floss 14. The first holder member 8 includes a valve 42 through which the dental floss 14 is drawn, which prevents leakage of the cleaning material from the body 4. The valve 42 allows dental floss 14 to be drawn with cleaning material thereon, while substantially sealing the chamber preventing leakage of cleaning material. Each section of dental floss 14 drawn from the body 4 is thus coated in the cleaning material.

The cleaning material is preferably a liquid, gel, paste or powder dentifrice. The cleaning material may act as an abrasive that aids in removing dental plaque and food from the teeth. The cleaning material may include a fluoride. The cleaning material may include an anti-bacterial agent. The cleaning material may include a remineralizer for reformation of enamel. The cleaning material may include a flavourant to encourage use of the dental floss.

In a modification to the second embodiment, the dental floss 14 is made of an absorbent material and, in this case, the cleaning material is carried from the body 4 absorbed in the dental floss 14 additionally or alternatively to being coated on the dental floss 14.

Optionally the valve 42 and the fillet 34 may be formed of the same part, located in the region of the connection between the first holder member 8 and the rest of the body 4.

In use, the section of dental floss between the first and second holder members 8, 10 can be replaced with another section as described above for the first embodiment.

It will be appreciated that there are various modifications beyond those already mentioned possible to the embodiments; indeed various modifications are possible to the modifications mentioned above. The nodes of the dental floss do not have to be formed from plastic balls; for example, they may be formed from knots in the dental floss. The nodes also do not have to be regularly spaced; for example, there may be cutting sections defined by the nodes which are of different length to the sections for cleaning, the cutting sections being located between the sections for cleaning. Preferably there is a plurality of sections on a continuous length of floss which are of length suitable for holding between the holding members 8, 10 in a position for flossing, but the length of the bridge could be adjustable to enable use with sections of different length.

Optionally, the dental flosser 2a, 2b may include securing means for better securing a section 14 in a position for flossing. For example, the dental flosser 2 may include a securing means for covering the part spherical recess 37 when a node 30 is located in that recess, thereby to further prevent any possibility of dislodging of that node during flossing. The securing means may take the form of a ring or part-ring slidable on the second holder member 10. Optionally the securing means such a ring or part-ring may be biased into a securing (for example covering) position, and may be movable to allow locating of a node so that a section in the flossing position can be tensioned and removing of that node.

Above the bridge 12 is resiliently flexible, but resilient flexibility may instead or additionally be provided in other aspects of the tensioning structure.

There may be resilient flexibility in a portion of the body adjacent the bridge for improved comfort when flossing.

The tensioning structure described above can be operated using finger pressure to apply or remove/partly remove a tensioning action to a pair of nodes to tension the section between the nodes and is thus a kind of switch. This kind of switch is not the only kind within the scope of the invention. Alternative switches are possible that are also operable to switch between a first state wherein said tensioning action is applied to nodes defining a section on said length and a second state wherein said tensioning action is at least partly removed from said nodes. The first state may be achieved by the user by snap-fit engagement of a node in the tensioning structure enabled by resilience in the tensioning structure, as in the embodiments described above, or by a user switching action.

For example, the first holder member may have a ring or part ring slidable along the first holder member and the part spherical recess may instead be a recess capable of receiving the whole of a node. When the node is located by a user partially in the recess and the length of the section is such as to impede complete location of the node in the recess, the ring or part ring can be slid over the recess by the user thereby to depress the node so that it is fully in the recess and thereby to tension the associated section. In this case, the ring or part-ring preferably engages over the recess, optionally in snap-fit engagement. The tensioning structure can be adapted for this, as would be clear to the skilled person. The ring or part ring is releasable from the position depressing the node. This arrangement using a ring or part-ring may also be used for further securing of a node, in a similar operational manner to that described above.

Optionally the ring or part-ring and the cutter 16 are formed of the same piece of material, for example metal.

Another example of a suitable kind of switch is a push switch. Such a switch could be configured to act on a node so as to tension an associated section, the tensioning structure being adapted appropriately by a skilled person. Pushing of the push switch would at least partially remove tension in the section so that the section could be removed. The pushing of the push switch may dislodge a node from the tensioning structure, or may just release tensioning action of tensioning structure on the node so that the user can remove the node.

It will also be appreciated that the dental flosser could be modified so that the second node 30b is removed from the first holder member 8 before the first node 30a is removed from the second holder member 10. The dental floss 14 could extend through the second holder member 10 rather than the first holder member 8. A switch described above at the second holder member 10 could instead be at the first holder member 8.

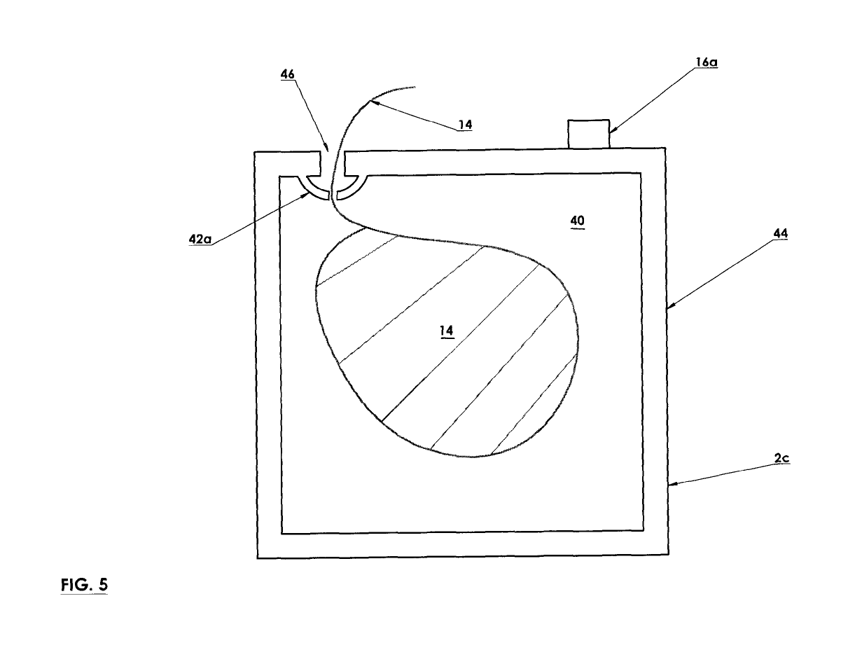

Referring to FIG. 5, in a third embodiment, a device for supplying dental floss, indicated at 2c, comprises a body 44 defining a chamber that contains the dental floss 14. The chamber also contains a cleaning material 40 of a kind already described above. The dental floss 14 is drawn through an aperture 46 in a wall of the chamber. A valve 42a is arranged at the aperture 46 to allow drawing of the dental floss 14, normally by a person intending to use some of the dental floss, while substantially preventing leakage of the cleaning material. In other words, the valve 42a acts to allow dental floss to be drawn with cleaning material thereon and/or absorbed therein, while substantially sealing the chamber to prevent leakage of cleaning material.

The dental floss 14 is preferably loose in the chamber, and may be wound and positioned to prevent tangling, with or without a bobbin, as described with reference to the first and second embodiments.

Preferably, the device 2c includes a cutter 16a to enable a user to cut away some of the dental floss.

In use, the dental floss 42a is drawn from the chamber by a user pulling on a free end of the dental floss 14. After the user has drawn a sufficient length for flossing, the user cuts the dental floss to be used and flosses in the conventional manner by appropriate finger action.

It will be appreciated that, where a dental flosser containing cleaning material has been described above having a tensioning structure for holding a section of drawn dental floss, embodiments of the invention are not limited to a any particular kind of dental flosser that holds dental floss in a position for flossing. Embodiments are also not limited to use with dental floss having nodes.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A dental flosser comprising a tensioning structure for holding a section of a dental floss for flossing, the dental floss being of continuous length and having on said length a plurality of spaced nodes defining a plurality of sections, wherein the tensioning structure is arranged to apply a tensioning action to a pair of nodes on said length, the pair defining a one of the sections, thereby to tension the section, and so that the one section is replaceable with another one of the sections on said length by drawing of dental floss from an unused portion of the dental floss, wherein the tensioning structure is operable to at least partially remove said tensioning action from the pair of nodes.

2. A dental flosser according to claim 1, wherein said tensioning structure is arranged or operable to apply said tensioning action to the pair of the nodes defining the other section after locating of the other section in the tensioning structure.

3. A dental flosser according to claim 1, wherein said tensioning structure comprises a switching means operable to switch between a first state wherein said tensioning action is applied to nodes defining a section on said length and a second state wherein said tensioning action is at least partly removed from said nodes.

4. A dental flosser according to claim 3 wherein the switching means comprises a resiliently flexible portion, flexing thereof at least partly removing said tensioning action.

5. A dental flosser according to claim 1, wherein the tensioning structure is operable to at least partially remove said tensioning action from the pair of nodes by application of finger pressure to the tensioning structure.

6. A dental flosser according to claim 1, wherein the tensioning structure comprises first and second members each for applying a tensioning action to a respective one of a pair of nodes defining a section.

7. A dental flosser according to claim 6, wherein the first and second members are joined by a bridge, wherein the tensioning action can be at least partially removed by flexing of the bridge by finger pressure.

8. A dental flosser according to claim 6, wherein the first member comprises a first floss guiding slot sized to prevent passage of a node therethrough, wherein the tensioning action comprises the action of the end of the walls of the slot on a one of the pair of nodes.

9. A dental flosser according to claim 8, wherein the second member comprises a second floss guiding slot sized to prevent passage of a node therethrough, wherein the tensioning action comprises the action of the end of the walls of the slot on the other of the pair of nodes.

10. A dental flosser according to claim 6, wherein, when tension in the section of the dental floss is at least partially removed, the one node is releasable from the first member and/or the second member.

11. A dental flosser according to claim 6, wherein, when tension in the section of the dental floss is at least partially removed, the other node is releasable from the second member.

12. A dental flosser according to claim 1, further comprising a cutter for cutting the dental floss and located for cutting at least a part of the length of the dental floss after it has been removed from between said first and second members.

13. A dental flosser according to claim 1, wherein the dental flosser substantially contains an unused portion of the dental floss.

14. (canceled)

15. A dental flosser according to claim 13, further comprising a body defining a chamber containing the unused dental floss, wherein the chamber contains a cleaning material for oral hygiene, wherein the body defines an aperture in a wall of the chamber through which dental floss is drawn, the dental flosser further comprising a valve at the aperture for substantially preventing leakage of the cleaning material from the chamber.

16. A dental flosser according to claim 13, further comprising a body defining a chamber containing the unused dental floss, wherein the chamber contains a cleaning material for oral hygiene, wherein the body comprises a handle.

17. A dental flosser according to claim 1, wherein the length of a section substantially corresponds to a length of dental floss that the tensioning structure is arranged to hold.

18. A dental flosser according to claim 1, wherein the section of floss located for flossing is located substantially parallel to the axis of the handle of the dental flosser.

19. (canceled)

20. (canceled)

21. A method of operating a dental floss holder to replace a section of dental floss held in a position for flossing with another section of the dental floss, the dental floss being of continuous length and having a plurality of spaced nodes thereon, pairs of the nodes defining sections, the method comprising:
operating the dental floss holder to at least partially remove tension in the section;
removing the section from the position and arranging the other section in the position for flossing and so that a tensioning action is applied to the pair of nodes defining the other section, wherein arranging the other section comprises drawing dental floss from an unused portion of the dental floss.

22. A method according to claim 21, wherein the dental floss holder comprises a tensioning structure for holding a section of the dental floss for flossing, and wherein operating the dental flosser holder to at least partially remove tension in the section comprises flexing the tensioning structure to at least partially remove said tension.

23. A method according to claim 22, wherein the flexing is by application of finger pressure.

24. (canceled)

25. (canceled)

26. (canceled)
